(19) United States
(12) Patent Application Publication
(10) Pub. No.: US 2014/0032688 A1
(43) Pub. Date: Jan. 30, 2014

(54) F.B. Immortal

(71) Applicant: Robert Anthony, Tamarac, FL (US)

(72) Inventor: Robert Anthony, Tamarac, FL (US)

(21) Appl. No.: 13/986,629

(22) Filed: May 20, 2013

Related U.S. Application Data
(60) Provisional application No. 61/688,703, filed on May 21, 2012.

(51) Int. Cl. H04L 29/08

(52) U.S. Cl. CPC H04L 67/306
USPC 709/206

(57) ABSTRACT

A social network design feature and direct revenue business model that activates and designates a persistant and perpetual state of electronic existance. Whereas the unique and never before implemented method preserves an individuals imprint on existance then, now, and always by elective contract and interactive contribution periodically and continually by ongoing and pre-programed imput by the user. In the most simple terms; if you want your social network page to persist as a historical record of “you”, and you elect to designate certain parts of your daily contributions to be permanent and pay a small fee according to the quantity of data saved, with a minimal amount at little or no cost, you can guarantee that if the site exsists, you exist. You may also elect to have a time capsule like pre-programed feature that will allow indefinite interaction on your page.

### CROSS REFERENCE TO RELATED APPLICATION

This method claims benefit and incorporates in its entirety by reference U.S. Provisonal Patent No. 61/688,703 Titled; F.B. Immortal filed May 21, 2012.

### I. FUNCTIONAL SPECIFICATIONS FOR A SOCIAL NETWORK DESIGN TECHNOLOGY INVENTION

### A. Nature and Field

This invention relates to online services and socila networks, communication devices, methods, indexing and storage on a social network data base and page.

### B. Background

The internet mainly functions via search engines and wed portals since 1991. Social networking sites like Facebook, Google, Plus, Myspace, current event, news and information sites, and online shopping, make up of most of the time spent online by unique visitors. The social network sites have become a virtual center of the universe electronically. Social netwroking sites devise systems to keep their user base active, captivated, and loyal to the brand with unique functions in media, music, art, friends, family, and interaction, to name a few. Using methods in messaging, photo sharing, and games ect., these sites face the peril of being outdone, or made obsolete by competing ventures in their business by the invention, implementation, and continued development of like products. They must keep pace with advancing technical thresholds and innovations. This invention creates a persistent, ongoing relevance for a social network in an ever changing market that has proven to be the top vulnerability of these kind of sites and continues to be the ultimate risk associated with investment in these products.

### C. Specification

The invention has a primary and main function to attract new users, keep existing users, and attract the demographic that is resisting the use of social networks because it lacks a system that is meaningful to them. Generally speaking, less technically inclined or more senior members of the community. This is accomplished by making every keystroke that a user invests, a proactive effort in their electronic immortality. The impact on brand loyalty is immeasurable. The more time and data a user invests, the greater the likelyhood that they will not abondon the effrot and continue with a given network and certainly not “jump ship” to the next social craze. As of late there has been a lot of news about the new problem for social networks. This being that there are literally thousands of profiles that go inactive on a daily basis due to death by accident, age or disease. One headline reads, “Facebook is becoming a virtual cemetery!” Some social networks have a method of memorialization of a users page. This method is after the fact and if a family member or friend requests so, the page is left in suspended animation and a limbo like state. The user has no function in the decison or the content left in posterity. One problem is that it is morbid and in some cases just becomes a sounding point for folks to leave sad messages in condolence. In worse scenarios, the page continues to send notices that are clearly not designed by the author. This invention solves the new problem. No longer will the user's social network page become a depressing epilogue or abruptly stagnant and irrelavant page. It will from one be a celebration and historical record for the life of the common man and be as alive and well before, during, and after the biologic stage of the individual.

### INVENTION SUMMARY

A method and design mechanism that creates a database and indexing system as a permanent biography of the user by declaration and elective design where the user can preserve the imput perpetually, periodically, and indefinitly. It allows an interactivity throughout life and further as programmed by a time capsule like feature of the design. The purpose of the invention is to build brand loyalty as in the “lifeblood” of the social network platform. This is accomplished several ways when a user self-builds with vested creative and factual representation, what is the essence of their lives. The users unique bio., as was also desribed in patent filing 60-057294 (1997), was in a timeline like format but this is not a necessary component of the current invention. It is unique and unimplemented in that it accomodates automatic transition to electronic permanence as an elective function. Where some services offer a memorialization if and only if one is nominated by a friend or relative. This system guarantees that a users efforts will be preserved for all practical time. It further allows for a time capsule (SIC) feature that allows interactive messaging from what is effectivly “electronic heaven”. The by-product of the design includes a designation of ones place in time, whether active or historical. The user is able to pre-program messages that will post to their unique page at pre-determined dates any time into the future. Strict components are desgined to aviod negative issues or morbidity and mortality as a focal point of the “new” phenom of social networks, that being they are becoming virtual cemeteries by virtue of the profile pages in a state of suspended animation when the user is unable to make meaningful contributions and has not designated a destiny for the data. The system is intended to attract everyone to contribute a truely complete record of history then, now, and always as a celebration of life and its story. A histroy book for the common man. One would elect to be a part of the “Immortal page” and attain that status in life and not just after in a fun, social experience. Ther are limits and options for the data and storage desired. Additional terms of service specify that “all practical time” be limited by solubility, viability, acts of god, war, ect., but far outweigh and exceed conventional methods of historical preservation. In other words; “If the site exists, you exist!”. . .

An important aspect of the invention claim is the financial business model as related to direct revenue support of the social network and the price association with affordability, maintanence and sustinance of the “super” database and investment to procure and guarantee the profileration of the model. First, the direct revenue impact for a social network is paramount. This being the largest critisism of all existing brands. Not one social network has developed a meaningful or significant direct revenue model that would satisfy investor concern relating to future stability and profitability as a strategy for long term success. What could be more long term then a direct revenue product that does not interfere with the “free aspect” of the existing model, in a self sustaining and indefinitly perpetuating product? Second, pricing structure for the various storage sizes is based on margins to guarantee solvency and profit, all at a low cost to the user. Finally, the business method will account for reinvestment of some profit to fulfill cost obligations.

### A BREIF DESCRIPTION OF VIEWS OF DRAWINGS

### I. Diagrams, Flowcharts, Drawings, Articles

A. There are 3 flowcharts, 2 diagrams, 1 drawing and 2 articles.

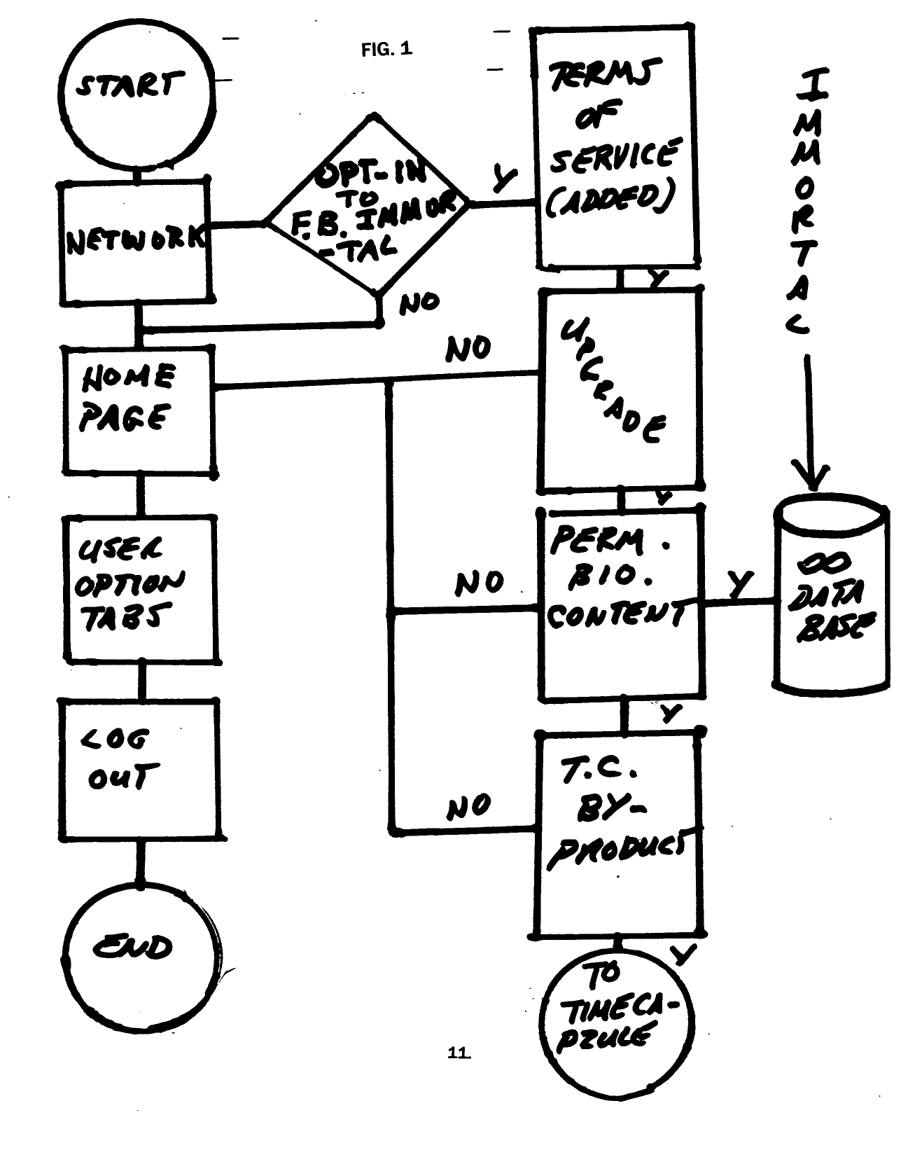

FIG. 1 . . . Flowchart F.B. Immortal data base model

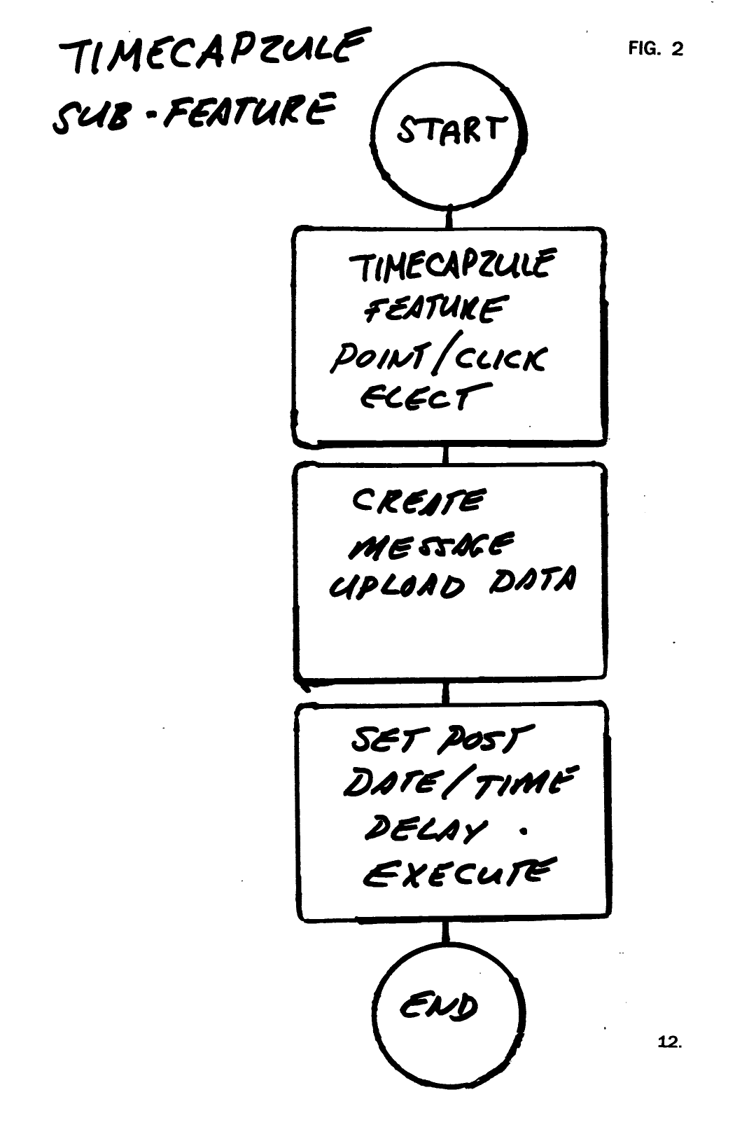

FIG. 2 . . . Flowchart Time capsule program feature

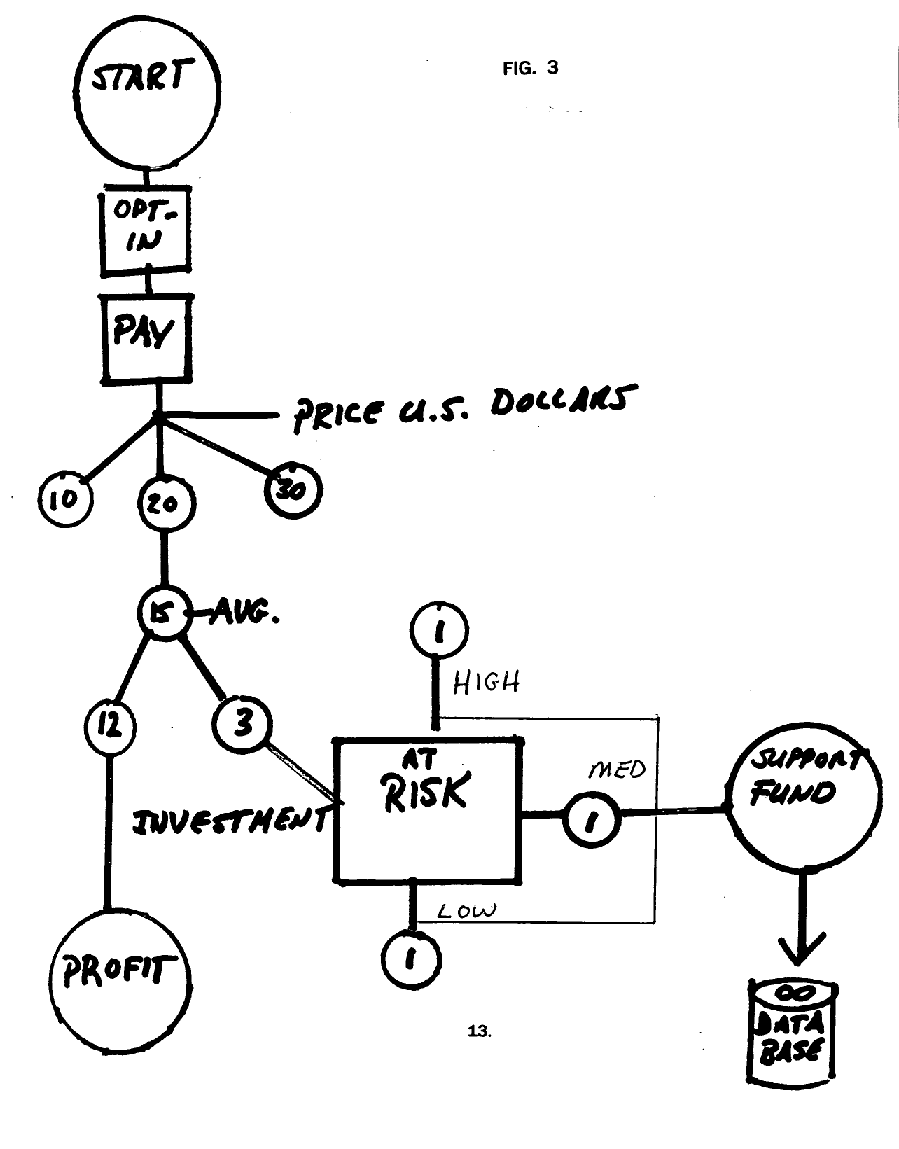

FIG. 3 . . . Flowchart Pricing revenue, investment

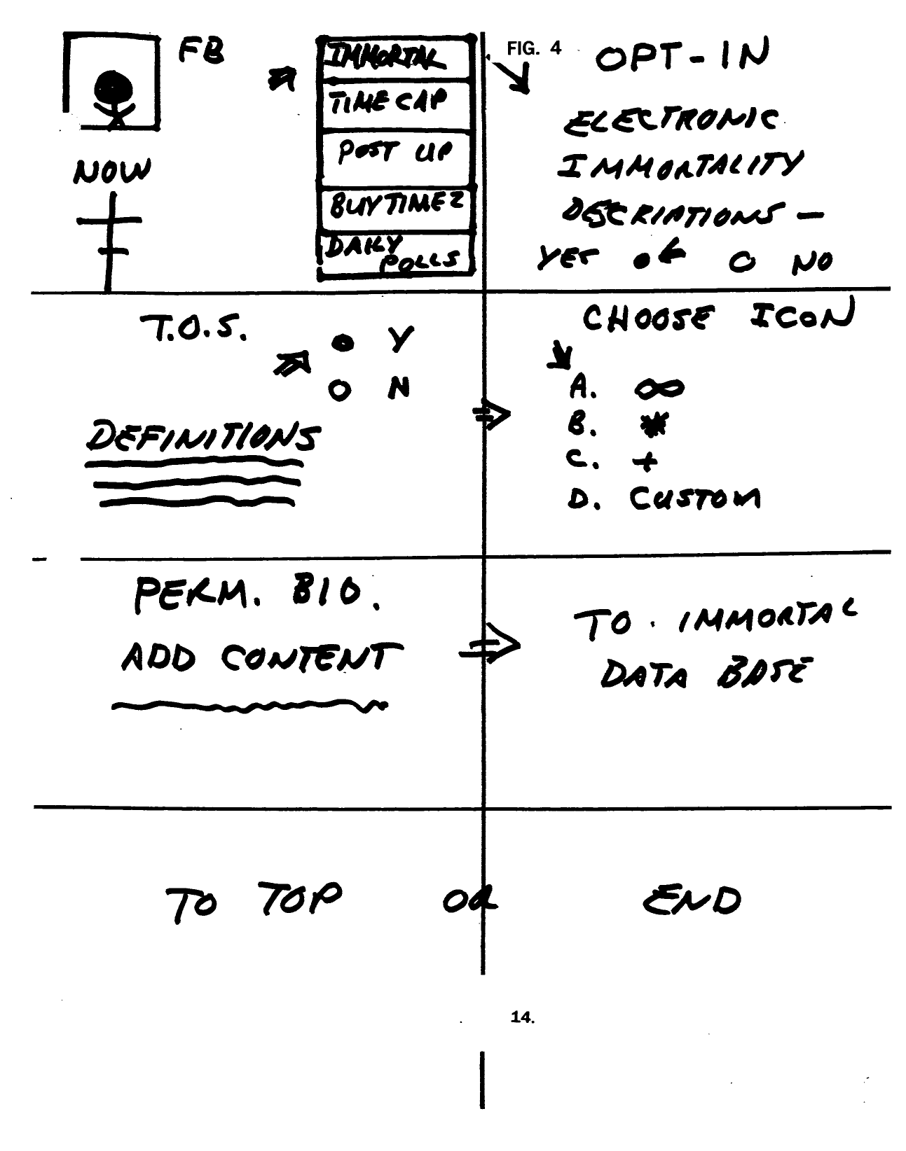

FIG. 4 . . . Diagram F.B. Immortal data base model

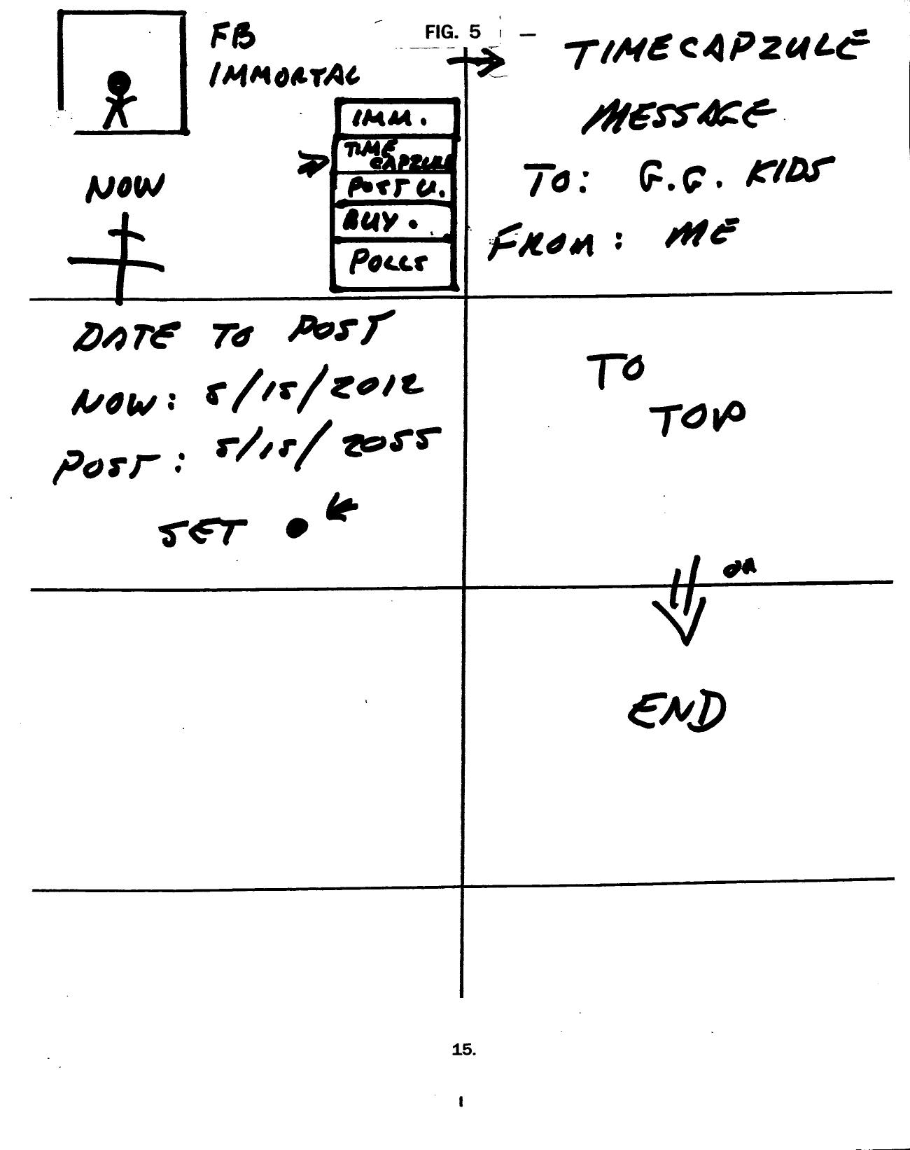

FIG. 5 . . . Diagram Time capsule program feature

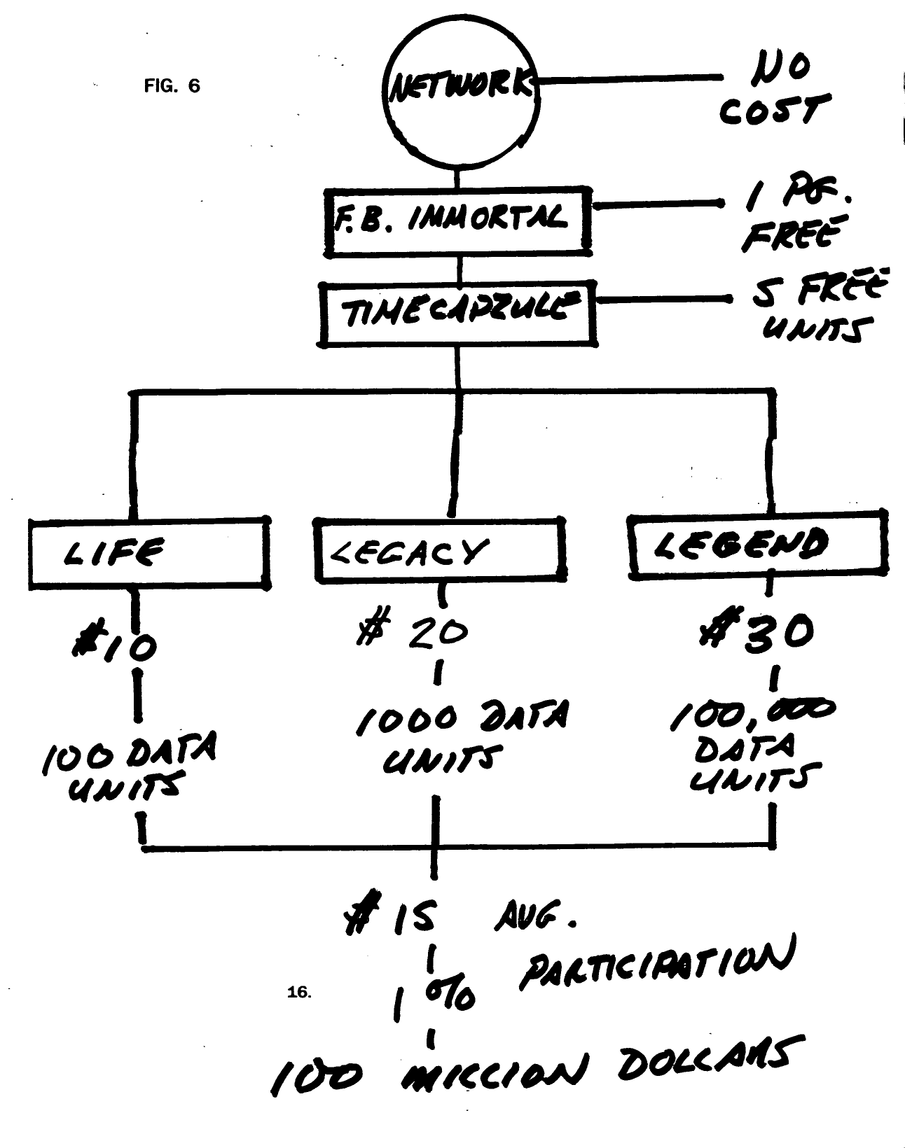

FIG. 6 . . . Drawing Direct revenue and pricing model

B. There are two related news articles attached to pages 24-30.

C. Ongoing costs in maintaining the data base and page in an indefinite and perpetual scenario fully described in FIGS. 1, 3, and 4.

D. The business model for direct revenue support is detailed in FIG. 6 and describes the dynamic approach to creating cash flow from a free product with premium featured that do not change the core product or function.

### DETAILED DESCRIPTION OF INVENTION

The present invention now will be described more fully here in after with reference to the accompany drawings, flowcharts, and diagrams in which some exapmles of the embodiments of the inventions are shown but these inventions may be embodied in many different forms and should not be construed as limited to the embodiments set forth here in, rather, these embodiments are provided by the way of example so that this discloser will satisfy applicable legal requirements and more closely establish what the methods accomplish in propriatary execution. These methods will direcly raise revenue in the 100's of millions on U.S. dollars with single digit percentage participation by users per calander year for major social networks or for new and upstart social networks to come inclusive of the prototype now in developement.

FIG. 1 Illistrates the process a user will encounter during an online interaction with a social network page given the option to participate, elect, pay, and contribute to a permanent data base or the F.B. Immortal electronic mechanism.

FIG. 4 Illistrates the pointer graphic in a walk through a point and click of a navigation through the elective process.

FIG. 3 In part shows the pricing method and investment support in maintainance of the system. The technical method of storing data is industry standard but enhanced by the financial model and is replenished by a virtual and financial “Fountain of Youth” whereas, as it is easily maintained by the constant flow of reinvestment and distribution of revenue in equity, growth, and profit seperate from the viability of the social networks primary financial engine. FIG. 1 and FIG. 4 also show the pathway for electing data that will be stored in the permanent data base or the temporary dtat base. In other words, some data will be periodic and not desired on the main record.

FIG. 2 Illustrates the “time capsule” (named for example purposes) where the user encounters the phase of the system that will allow for pre-planned or pre-programed interactivity on the F.B. Immortal mechanism. FIG. 5 shows the point and click navigation of the process. Where the user elects the date, time, and content to be introduced to the page.

FIG. 3. illustrates the pricing, business, and investment model for the system. It is an example with arbitrary but reasonable figures in an expression of effectiveness.

FIG. 6 Illustrates a simple breakdown of revenue flow through the system and the marketing method of exacting user participation at an optimum.

The methods are very straight forward. This has never been offered, attempted, or otherwise utilized in any form on any social network. However, the information has been on record for the entirety of the year in provisional patent protection. The methods are unique and unimplemented or protected by any known patent or filing but may now be in a “first to file” race to full utility patent protection. Included are news articles related to “the problem” with the social network phenomenon. I submit this patent application as the “solution”.

1. A method for enhancing a social network page by making it a permanent perpetual data base of personal information that will exists indefinately by direct revenue financial contract and self maintaning technical and financial model. The method that by conscious designation and by value added contract will persist electronically past, present, and future regardless of biological conclusivity. Whereas the user can elect and plan to imprint the history, life and ongoings on their page with the guarantee and commitment the page will not linger in suspension and inactivity or irrelevance. Whereas the page will not simply be a memorialization, but merely switch to a biographical record and automated presence of the user. A method of perpetual electronic existance and in effect; electronic immortality.

2. A system and mechanism that allows pre-programed interactivity via according to claim 1, where messages, data, information, and photos or storable imput is revealed at precise moments as ordered and perscribed by the user.

3. A method a business model according to claim 1, that is fortified by direct and/or indirect revenue in a pricing, and investment model that will maintain the physical requirements of the data base and the support in guarantee of the contract in perpetuity. The method desribed in FIG. 6 and FIG. 1, that will allow the system to persist as long as the site exists.

4. A method that according to claims 1 and 2 can be supported by a pricing structure from 0-100 U.S. dollars. Whereas the structure is by direct revenue and/or the intrinsic value associated with subscriber or member volume on a given site.

5. A method that according to claims 1, 2, and 3, that maximizes the brand and fortifies the user base by the accumulation of data invested by the user where as the data grows, the value and content increases geometrically.
